(19) United States
(12) Patent Application Publication
(10) Pub. No.: US 2010/0211301 A1
(43) Pub. Date: Aug. 19, 2010

(54) System and method for analyzing traffic flow

(76) Inventor: Scott McClellan, Heber, UT (US)

Correspondence Address: STEPTOE & JOHNSON LLP, 1330 CONNECTICUT AVENUE, N.W., WASHINGTON, DC, 20036, US

(21) Appl. No.: 12/379,152

(22) Filed: Feb. 13, 2009

(51) Int. Cl. G06F 19/00; G01C 21/30

(52) U.S. Cl. 701/119; 701/208

(57) ABSTRACT

A system and method for analyzing traffic flow comprises receiving location reports from a plurality of mobile devices, each of the location reports identifying a current location and current speed for a particular mobile device. For each of the location reports, the system identifies a current street from a street mapping database using the current location. The system stores the current speeds for the mobile devices so that each of the current speeds is associated with a street in the street mapping database. The current speeds may be stored in the street mapping database or in a separate database that is linked to the street mapping database.

### TECHNICAL FIELD

The present invention relates generally to a system and method for determining traffic speeds on a street based upon information from mobile device users using the street.

### BACKGROUND

Static street mapping data, such as posted speed limits, is available from companies such as NavTeq and Tele Atlas. The street mapping data may include street location, street names, posted speed limits, numbers of lanes, travel direction, and other information. The street mapping data does not reflect current traffic conditions, such as rush-hour traffic congestion, construction zones, traffic accidents, weather conditions or other events that reduce the actual vehicle speed on streets.

Current street data, such as actual vehicle speeds, may be available from current observations, such as information provided in commercial radio traffic reports. However, these reports typically address only major traffic delays on major thoroughfares. Accordingly, current conditions on the vast majority of streets are not available on demand. Additionally, current traffic reports are not always available. Typically, such radio traffic reports are available only during rush-hour periods. If such traffic reports are made outside of rush-hour periods, then they are usually only available a few times each hour. Therefore, current traffic information, such as road speeds or closures, are not available to drivers for all streets.

### SUMMARY OF THE INVENTION

These and other problems are generally solved or circumvented, and technical advantages are generally achieved, by preferred embodiments of the present invention in which a system and method for analyzing traffic flow comprises receiving location reports from a plurality of mobile device, each of the location reports identifying a current location and current speed for a particular mobile device. For each of the location reports, the system identifies a current street from a street mapping database using the current location. The system stores the current speeds for the mobile devices so that each of the current speeds is associated with a street in the street mapping database. The current speeds may be stored in the street mapping database or in a separate database that is linked to the street mapping database.

The system may compare one or more current speeds for a particular street to a posted speed limit for that street. The posted speed limit may be obtained from the street mapping database. The system identifies current speeds that are more than a threshold amount below the posted speed limit for the particular street. The threshold amount may be selected for the particular street. The system may designate the particular street as having slow traffic, if a preset number of current speeds for the particular street are more than the threshold amount below the posted speed limit for the particular street.

In another embodiment, a system and method for monitoring traffic flow comprises receiving messages from a plurality of wireless devices, the messages identifying a speed and a location for the wireless device. The system may store one or more device speeds associated with a particular street, where the particular street is identified using the device location. An observed speed limit may be computed for the particular street using the stored device speeds. The system may compare the observed speed limit to a posted speed limit for the particular street to determine the relationship between the posted speed limit and the observed speed limit. The observed speed limit may be greater than, equal to, or less than the posted speed limit. The system may further determine if the observed speed limit is different than (e.g., less than, greater than, etc.) the posted speed limit by at least a specified amount. For example, if the posted speed limit is 55 MPH, the system may determine if the observed speed limit is less than 55 MPH by at least 10 MPH.

If the observed speed limit for a particular street is less than the posted speed limit by more than a specified amount, then the particular street may be marked, designated or flagged in a street mapping database. Following the example above, if the observed speed limit is 15 MPH less than the posted speed limit, then the street may be flagged in the database. The flag may indicate a street that is congested or that has potential traffic accidents, construction zones, or other problems. Two or more of the stored device speeds may be averaged to compute the observed speed limit. The system may use all the speed data available to compute an average observed speed, or it may use speed data received during a certain period. A user may request data associated with the streets in a street mapping database. The system may provide observed speed limit information for the particular street in response to a query.

Another embodiment of the invention comprises a system and method for estimating a speed limit on a street based upon the number of users detected on that street. The method may comprise receiving a number of current speed reports from wireless devices. The wireless devices are associated with a particular street. A reported speed limit for the street is computed using the current speed reports. The reported speed limit may correspond to previously observed speed limits on the street for a particular number of users. The method may further comprise averaging two or more of the current speed reports received within a specified period to compute the observed speed limit. A current location report may be received with each current speed report from the wireless devices. The current speed reports may be associated with the street using the current location report. The method may further comprise identifying a traffic condition at a specific location by receiving current location and speed reports from wireless devices and searching a street mapping database using location data in the current location reports.

In another embodiment, a system and method for identifying a location of a street comprises receiving current location reports from wireless devices and searching a street mapping database using location data in the current location reports. Some of the location reports may be from devices that are traveling on streets that do not appear in the database. The system may identify selected location data that does not correspond to streets in the street mapping database. The system may then analyze the selected location data to identify areas that correspond to streets that are missing from the street mapping database. For example, the system may identify areas wherein a path appears to be formed between two existing streets in the street mapping database, where the location of the path is designated by the selected location data. The system may add the path to the street mapping database as a new street. The system may also assign a speed limit to the new street based according to a design previously discussed.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of an exemplary embodiment of a mobile device for use with embodiments of the invention;

FIG. 2 is diagram of an exemplary system for use with embodiments of the invention;

FIG. 3 illustrates traffic use on a street being monitored by embodiments of the invention;

FIG. 4 illustrates a flowchart for an exemplary embodiment of a method for analyzing traffic flow; and

FIG. 5 illustrates a flowchart for an exemplary embodiment of a method for estimating traffic speed.

### DETAILED DESCRIPTION

The present invention provides many applicable inventive concepts that can be embodied in a wide variety of specific contexts. The specific embodiments discussed are merely illustrative of specific ways to make and use the invention, and do not limit the scope of the invention.

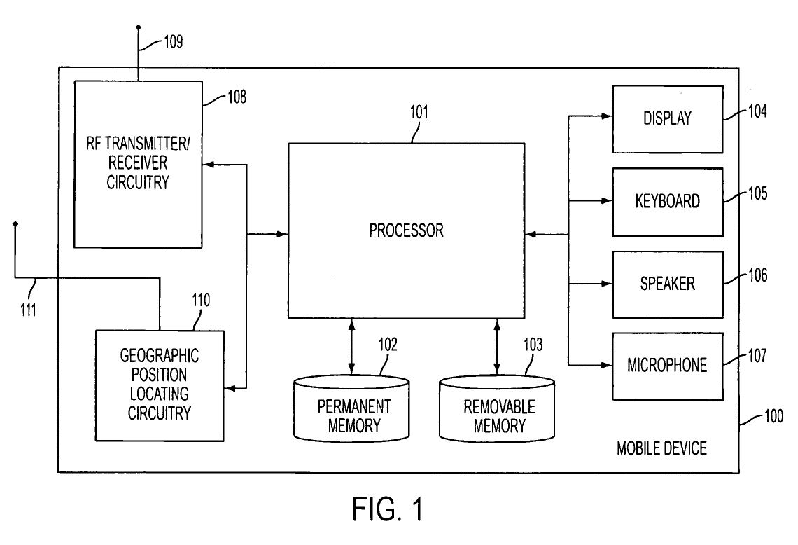

With reference to FIG. 1, there is shown mobile device 100, which may be, for example, a mobile, satellite or cellular telephone, personal digital assistant (PDA), pocket PC, smart phone, or pager. Processor 101 controls the operation of mobile device 100. Processor 101 may be a general use processing device having software designed to control the components of mobile device 100. Alternatively, processor 101 may be a specially designed circuit or device, such as an application specific integrated circuit (ASIC), that is particularly designed for use in mobile device 100. Processor 101 may use firmware or software, such as an operating system, for control and operation. Operating firmware, software and other data may be stored in permanent memory 102, which may be, for example, a random access memory (RAM), read only memory (ROM), electrically erasable programmable memory (EEPROM), magnetic media, or other storage device. Processor 101 may also use firmware, software or other data stored on removable memory 103, which may be, for example, a secure digital (SD) memory card, XD picture card, smart media memory card, CompactFlash card, Memory Stick, MultiMedia Card, or microdrive device.

Processor 101 may provide voice, text and/or data communication functionality to users. Processor 101 controls and exchanges input/output information with the user via interfaces such as display 104, keyboard, 105, speaker 106, and microphone 107, for example. Processor 101 may also provide an interface to devices external to mobile device 100, such as “hands free” devices that allow the user to operate mobile device 100 without having to hold the device. For example, Bluetooth devices may communicate with mobile device 100 via a Bluetooth interface (not shown). Mobile device 100 may also include other interfaces or devices (not shown), such as a camera, barcode reader, RFID interrogator, transponder or tag, fingerprint reader, or Infrared port.

Mobile device 100 interfaces with one or more communication networks or systems via RF transmitter/receiver (transceiver) circuitry 108 and antenna 109. RF transceiver circuitry 108 may provide communications with any RF, Infrared, or optical communication system, such as, for example, cellular or mobile telephone networks, satellite communication networks, wireless data networks, Bluetooth, WiFi, WiMAX or 802.11 networks. RF transceiver circuitry 108 may provide communications using any technology, protocol, standard or access method, such as 2G or 3G technologies known as Time Division Multiple Access (TDMA), Global System for Mobile communications (GSM), General Packet Radio Service (GPRS), Enhanced Data rates for GSM Evolution (EDGE), Enhanced GPRS (EGPRS), Code Division Multiple Access (CDMA), Wideband Code Division Multiple Access (W-CDMA), Universal Mobile Telecommunications System (UMTS), CDMA2000 1×RTT, CDMA2000 1xEV-DO, CDMA2000 1xEV-DV, or any other later developed communication technology. Antenna 109 may be an internal or external antenna.

Mobile device 100 also includes geographic position locating circuitry 110 that identifies, generates or calculates location information associated with a current location of mobile device 100. Geographic position locating circuitry 110 may be, for example, a global positioning system (GPS) that receives location data from satellites via antenna 111 or may use radiolocation from a cellular network to determine the current location of mobile device 100. Antenna 111 may be an external or internal antenna. Other navigation or location-determining systems may also be used, such as inertial navigation systems that update mobile device 100's location as it moves from a known position, or terrestrial-based radio navigation systems, such as Long Range Aid to Navigation (LORAN), Tactical Air Navigation (TACAN), or VHF Omnidirectional Range (VOR). In other embodiments, geographic position locating circuitry 110 may use transmissions or data from cellular or wireless network towers to determine a geographical location.

Processor 101 may run a number of applications to support voice, data, email, or text communications. Processor 101 may also run a location application that provides a current location for mobile device 100 to processor 101 for use with other applications or to provide location information to the user. For example, the user may access a mapping or search application on mobile device 100 that obtains data from the location application to identify the current location of mobile device 100. The location application may receive location information from geographic position locating circuitry 110. The information from circuitry 110 may identify mobile device 100's current location, such specific geographic coordinates, latitude/longitude, street address, or map coordinates, for example, or may provide information that allows the location application to determine or calculate the device's current location. The location application may use other information to identify a current location, such as the identification of a network component that mobile device 100 is in communication with, which may be, for example, a base station, mobile switching center, support node, serving node, access point, satellite, or other network node, component or device. Mobile device 100's location may be determined to varying degrees of specificity and accuracy depending upon the information available and the location method used. For example, GPS location data may be accurate to within a meter of the mobile device 100's location, but identifying a base station that mobile device 100 is communicating with may provide the device's location only to an area of several square miles.

Processor 101 running a location application may use street mapping data to display a map of the current location to the user via display 104, such as the current street on which mobile device 100 is located. Additional information may be presented to the user from a street mapping database, such as a street name, driving direction, posted speed limit, expected traffic conditions, or the like. The street mapping data may be stored, for example, in memories 102 or 103. A location application may also calculate, determine and/or display routing information to a selected destination. In one embodiment, the street mapping database stored in memory 102 or 103 may be updated, for example, by the user or a third party. The user driver may enter data, such as updated traffic or construction information, updated posted speed limits, street names, or street conditions, via keyboard 105. Alternatively, or additionally, mobile device 100 may receive updated street mapping data, such as via a wireless transmissions received via RF transceiver 110 from a third party, such as service provider, street mapping data provider, or other person or entity.

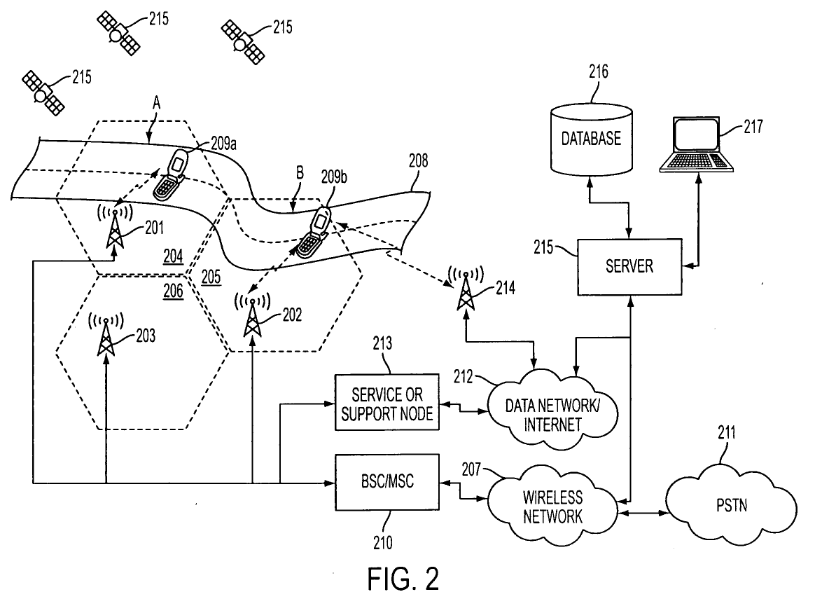

FIG. 2 illustrates systems and networks operating according to embodiments of the invention. Radio base stations 201-203 may be base transceiver stations (BTS), base station controllers (BSC) or UMTS node Bs, for example, that provide communication to wireless devices within geographic areas or cells 204-206. Base stations 201-203 may be components of wireless network 207 that serves a larger geographic area. Portions of street 208 are covered by cells 204 and 205. Other cells (not shown) may cover the remainder of street 208 and provide wireless service to people and vehicles using street 208.

Device 209 moves along street 208 from location A (209a) to location B (209b). In one embodiment, device 209 may be a mobile or cellular telephone, such as device 100 (FIG. 1). Device 209 may communicate with base stations 201 and/or 202, which provide coverage to wireless devices within the cells that overlap street 208 at locations between A and B.

Device 209 is in communication with wireless telephone network 207 via the appropriate radio base station 201 or 202 and BSC/mobile switching center (MSC) 210. Wireless telephone network 207, which may be, for example, any well-known 2G or 3G cellular or mobile telephone network that provides telephone services between a user, such as device 209, and a publicly switched telephone network (PSTN) 211. Alternatively, device 209 may communicate with a public or private data network 212 via service or support node 213. Data network 212 may be the any public or private data network, such as an Internet, intranet, extranet, or wide or local area network (WAN/LAN). Node 213 may be a Gateway GPRS Support Node (GGSN), Serving GPRS Support Node (SGSN), Packet Data Serving Node (PDSN), or other node or component adapted to facilitate packet data communications between a wireless device and a data network.

In other embodiments, device 209 may be a satellite telephone, PDA, pocket PC, smart phone, or pager. In those embodiments, device 209 may communicate with data network 212 via support node 213 or via other wireless networks 214. For example, wireless network 214 may be a satellite network, WiFi network, Bluetooth network, or data network access point.

Device 209 may determine its location using data received from satellites 215, which may be GPS satellites, for example. Alternatively, mobile device 209 may determine its location generally by identifying the location of serving base station 201 or 202. Similarly, mobile device 209 may determine its general location by determining the coverage areas 204 and 205. Depending upon the base stations, capability, and network design, the coverage area of cells 204-206 may vary from a small local area to several square miles. Mobile device 209 may also use the identity of serving MSC 210 to identify its location as being within a larger area, such as a particular metropolitan service area.

Mobile device 209 may determine if it is moving by identifying a change or handover from one serving base station or MSC to another. For example, if mobile device 209a moves from coverage area 204 into coverage area 205, then the wireless network may handover control from base station 201 to base station 202. Upon detecting handover commands from the wireless network, mobile device 201 may determine that it is moving. Alternatively, device 209 may determine that it is moving and calculate its velocity using internal GPS circuitry, such as geographic position locating circuitry 110 (FIG. 1) or other internal location application circuit or software.

Device 209 may report device information, such as a location and speed of device 209, to central server 215, which may be any processor-based computing system as is well known. In one embodiment, device 209a (at location A) may establish an interactive session with server 215 via a connection through base station 201, node 213, and data network 212. Information representing device 209's location and speed may be sent in data packets during the session. The interactive session may continue as device 209 is handed off to base station 202 (e.g. device 209b at location B) using known techniques. Data packets may be exchanged via a session established through base station 202, node 213, and data network 212. In other embodiments, device 209 may send location and speed data via electronic mail or text messages to server 215. Preferably, the information sent from device 209 to server 215 includes at least a device identifier, device current location, and current device speed. Other information, such as the time the device data was recorded, current device velocity (i.e. device speed with a directional vector), current direction of travel, average speed or velocity over a period, or current or average acceleration, may be included.

Device information for device 209 and other devices may be stored in database 216. Device information stored in database 216 may be sorted or retrieved based upon a reported device identifier, device location, device speed/velocity, time the device data was recorded, or other parameters. A user may access, review or retrieve the stored device information using a personal or laptop computer 217. Computer 217, server 215 and database 216 may be collocated or located remote from each other. If located remote from each other, computer 217, server 215, and database 216 may communicate via a public or private data network, such as network 212.

The device information may be used, for example, to determine how fast the device is moving on a particular street, such as how fast device 209 is moving on street 208. This information may be compared to other data associated with the street, such as posted speed limits, construction zones, or traffic signals. Detailed street mapping data is available from companies such as NavTeq and Tele Atlas. The street mapping data may include street location, street names, posted speed limits, numbers of lanes, travel direction, and other information. Additional permanent and temporary street information may be added to the street mapping data, such as road conditions, traffic conditions, weather conditions, construction information, or street closures. This information may be added or updated, for example, by drivers on the street or by third parties, such as a street mapping company, government agency, police department, department of transportation or the like.

In embodiments of the invention, street conditions may be determined, predicted or estimated based upon the data provided by mobile devices using that street. For example, wireless device 209 may transmit a speed or velocity and a location to server 215 from location A. The location information for device 209a may be transmitted as a latitude and longitude, for example. Server 215 may identify the location of device 209a as corresponding to point A on street 208. Server 215 may then compare the speed reported by device 209a to a posted speed limit for street 208. The difference between the posted speed limit and the speed reported by device 209a may be used to evaluate traffic conditions on street 208 in location A. For example, if device 209a reports a speed that is equal to or greater than the posted speed limit for location A, then sever 215 may evaluate that there are no traffic delays, construction zones, weather problems or other sources of delay in area A.

However, if the speed reported by device 209a is significantly below the posted speed limit, then server 215 may determine that some traffic delay is present in location A. To avoid false identification of adverse road conditions, server 215 may further evaluate whether some known road condition may be causing the speed of device 209a to be below the posed speed limit. For example, if a traffic signal, cross street, railroad crossing, or other known road condition is present on street 208 at location A, that road condition may cause device 209a to be stopped or traveling below the posted speed limit. If no such street condition exists, however, then server 215 may identify location A as a potential traffic jam, construction zone or other adverse road condition. Additionally, assessment of the speed average differential that is significant can be further analyzed according to historical speed averages per time and date.

Wireless device 209 may report its location and speed to server 215 at any regular or irregular intervals or events. For example, device 209 may report its speed and location every five minutes, every fifteen minutes, or at some other period. Alternatively, device 209 may report its speed and location when its speed changes by a certain amount, such as when its speed changes by ten or twenty miles per hour. In other embodiments, device 209 may report its location and speed based upon location or other events, such as when it changes from one cell coverage area to another, when it changes from one street to another, when it passes an intersection, or when it has traveled a certain distance. As device 209 travels from point A to point B, it may determine that a predetermined period of time has expired, that it traveled a predetermined distance, or that it changed from cell 204 to 205. Based upon one or more of these events, device 209 reports its speed and location at point B to server 215.

Server 215 may be capable of initiating messages to device 209 requesting a speed and location or other report. This would allow server 215 to request speed and location from a plurality of registered devices or from specific devices, such as 209. For example, after receiving one or messages from device 209, server 215 may determine that device 209 is traveling on street 208. A user on computer 217 may access speed and location data on server 215 and database 216. The user may request updated information for a particular street, such as street 208. In response to the user's query, server 215 may initiate a message to device 209 requesting updated speed and location information. Upon receiving this information, server 215 may provide the user at computer 217 with current speed and traffic information for street 208.

It will be understood that the term “street” as used herein may refer to any throughway, including, without limitation, any interstate, state highway, main thoroughfare, minor thoroughfare, boulevard, street, road, alley, path, trail, or driveway that can be traversed by a motorized or unmotorized vehicle, animal or person.

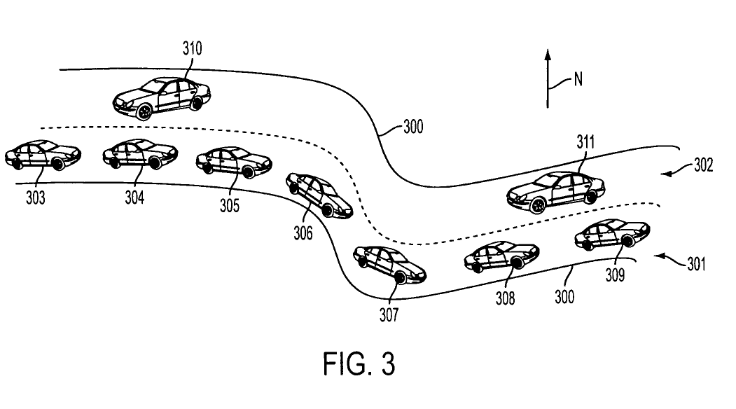

FIG. 3 illustrates a plurality of vehicles 303-311 traveling on street 300. Vehicles 303-309 are traveling East-bound in lane 301, and vehicles 310 and 311 are traveling West-bound in lane 302. The operators of one or more of vehicles 303-311 may have a wireless device, such as device 100 or device 209. As noted above with respect to device 209, devices in vehicles 303-311 may report their location and speed at regular or irregular intervals to a traffic monitoring server, such as server 215. Using the information from wireless devices in vehicles 303-311, the traffic monitoring server may collect data about street 300, such as traffic speed, traffic congestion, or other characteristics of street 300. Although the exemplary embodiment illustrated in FIG. 3 shows vehicles, such as cars, as using street 300, it will be understood that the invention is not limited to such embodiments. Wireless and mobile devices on any motorized or unmotorized vehicle, animal, or person using street 300 may be used with the invention. For example, location reports from wireless devices carried by operators or passengers on public or mass transportation, such as a bus or train, may also be used.

Location information from wireless devices in vehicles 303-311 may be correlated to street 300 by the traffic monitoring server. Data for street 300 may be stored in a street mapping database, such as in sever 215 or database 216 (FIG. 2). If the location information is specific enough, the traffic monitoring server may be capable of identifying which lane, 301 or 302, is being used by the associated vehicle. In other embodiments, the wireless devices may send velocity or direction of travel information that the traffic monitoring server may use to identify the relevant lane 301 or 302. If the wireless devices used for speed and travel information are sufficiently accurate, their location path can be used to further define and/or refine lane descriptions and locations. Using information from one or more wireless devices in vehicles 303-311, the traffic monitoring server may collect large amounts of movement data for street 300 or any other street. For example, Table 1 illustrates information that is received at the traffic monitoring server from vehicles 303-311.

TABLE 1

| Vehicle | Location | Speed |
|---|---|---|
| 303 | Lane 301 | 32 MPH |
| 304 | Lane 301 | 35 MPH |
| 305 | Lane 301 | 34 MPH |
| 306 | Lane 301 | 32 MPH |
| 307 | Lane 301 | 33 MPH |
| 308 | Lane 301 | 34 MPH |
| 309 | Lane 301 | 36 MPH |
| 310 | Lane 302 | 65 MPH |
| 311 | Lane 302 | 60 MPH |

The information may be stored in a database, such as database 216, and may be available to users, such as via computer 217. The information may be further processed, such as by traffic analysis software applications running on sever 215, to determine the average speed and congestion information shown in Table 2. Table 2 also shows a posted speed for the locations or lanes, which may be retrieved, for example, from a street mapping database.

TABLE 2

| Location | Average Speed | Posted Speed | Congestion |
|---|---|---|---|
| Lane 301 | 33.7 MPH | 55 MPH | 7 Devices |
| Lane 302 | 62.5 MPH | 55 MPH | 2 Devices |

The traffic monitoring server may determine actual, estimated or average speeds in lanes 301 and 302 as shown in Tables 1 and 2. This information may be compared to posted speed limits to determine whether traffic is moving at posted speeds. In the example of Table 2, the traffic in lane 301 is moving approximately 21 MPH slower than posted speeds. The traffic monitoring server may identify lane 301 as having unexpected road conditions. The traffic monitoring server may use this information in a number of ways, such as updating the street mapping database to include actual speeds in lanes 301 and 302. Alternatively, the traffic monitoring server may provide alerts to drivers that are using lane 301 or who have routes that will traverse lane 301. A threshold may be set in the traffic monitoring server so that such alerts or updates are sent to the street mapping database or to drivers when observed traffic conditions differ from expected conditions by more than the threshold amount. For example, a 15 MPH threshold may be set for street 300. When the observed average speed in lane 301 drops more than 15 MPH below the posted speed, then the traffic monitoring server may notify other devices or people of the traffic conditions on lane 301.

Additionally, the traffic monitoring server may determine a number of vehicles that have reported a location and speed for lanes 301 and 302. In the case of lane 301, which has seven wireless devices reporting speeds, the traffic monitoring system may determine that traffic congestion, such as rush-hour traffic, is a cause of the reduced speed in lane 301.

In other embodiments, posted speed limits for lanes 301 and 302 may not be available from a street mapping database. Using the data collected from wireless devices in vehicles 303-311, as shown in Tables 1 and 2, a traffic monitoring server may update the street mapping database with observed vehicle speeds. Additionally, data observed at different times of the day may be collected so that estimated speed limit information is available to the street mapping database for different times of day.

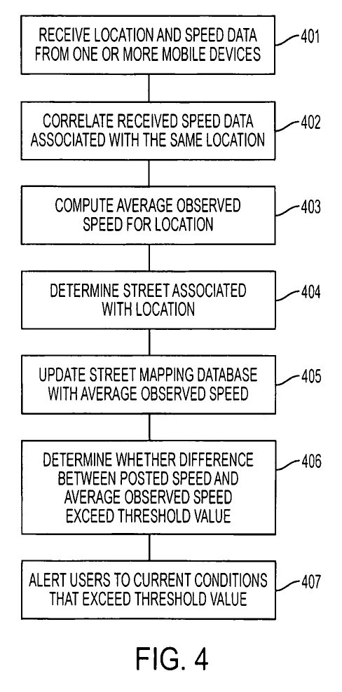

FIG. 4 illustrates a flowchart for an exemplary embodiment of a method for analyzing traffic flow. The method illustrated in FIG. 4 may be implemented, for example, using mobile device 100 or 209 and server 215, but is not intended to be limited to such configurations. Moreover, it will be understood that the steps illustrated in FIG. 4 may be performed in the order indicated, or in any other order, or simultaneously, or in conjunction with other steps or methods.

In step 401, location and speed data is received from one or more mobile devices. The data may include other information, such as acceleration, direction of travel, etc. In step 402, the received speed data is correlated by location so that speed data associated with the same location is identified. In step 403, an average observed speed is computed for each location. In step 404, the street associated with each location is determined. For example, the street may be identified by a latitude and longitude reported by the mobile device. In step 405, a street mapping database is updated with average observed speed information. In step 406, a traffic monitoring server or other application determines whether the difference between the posted speed limit and an average observed speed exceeds a threshold value. In step 407, if the observed speed exceeds the threshold value, then users are alerted to the current street conditions.

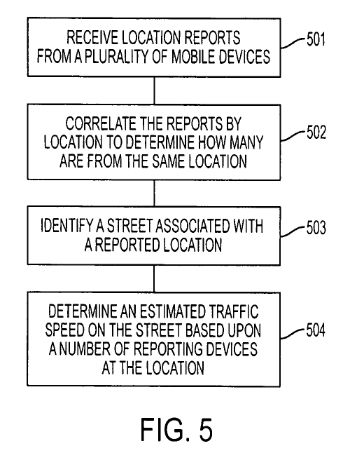

FIG. 5 is a flowchart illustrating another exemplary embodiment of the invention. The method illustrated in FIG. 5 may be implemented, for example, using mobile device 100 or 209 and server 215, but is not intended to be limited to such configurations. Moreover, it will be understood that the steps illustrated in FIG. 5 may be performed in the order indicated, or in any other order, or simultaneously, or in conjunction with other steps or methods. FIG. 5 is directed to a method for estimating the current speed and/or posted speed limits for one or more streets based upon the amount of traffic on the streets. The volume of traffic may be determined or estimated by the number of wireless devices that are using the street. In step 501, location reports are received from a plurality of mobile devices. In step 502, the reports are correlated by location to determine how many are from the same location. In step 503, a street associated with a reported location is identified. In step 504, an estimated traffic speed on the street is determined based upon the number of reporting devices at the location. Table 2 illustrates an example in which the number of users or the congestion on a street can be correlated to a observed speed. Referring to Table 2, for example, if the number reporting devices is two on a particular section of road 300, the speed on the street may be estimated to be 65 MPH. Alternatively, if the number of reporting devices is seven, then the speed may be estimated to be 33 MPH. Additionally, there may be a “quality” value or grade given to the “estimated” average speed for a given street according to the number units reporting. This “quality” value or grade may be used to identify the statistical significance of the speed estimate.

In another embodiment of the invention, the availability of a particular street, such as street 300 (FIG. 3), is apparent by the reports from wireless devices 303-311. When a traffic monitoring server receives a location report it may compare that location to a street mapping database in order to identify street 300. However, if street 300 is a new street that is not yet included in the street mapping database, then a query using the wireless device location data will not identify a street. The traffic monitoring sever may track such locations over a period of time and determine that a street is missing from the street mapping database. For example, if a number of locations on street 300 are reported by different wireless devices over the period, but no street in the database corresponds to the location, then the traffic monitoring server may determine that a new street should be added to the database. The traffic monitoring server may flag the location for further investigation and potential update to the street mapping database.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A central monitoring server for performing a method of analyzing traffic flow, the method comprising:
receiving a location report from each of a plurality of mobile devices, each location report identifying a current location and current speed for a corresponding mobile device;
identifying a particular street from a street mapping database using the current location identified in one or more location reports; and
storing one or more current speeds for the mobile devices so that each current speed is associated with the particular street in the street mapping database.

2. The central monitoring server of claim 1, wherein the method further comprises:
storing the current speed in a separate database that is linked to the street mapping database.

3. The central monitoring server of claim 1, wherein the method further comprises:
comparing the one or more current speeds associated with the particular street to a posted speed limit for the particular street.

4. The central monitoring server of claim 3, wherein the method further comprises:
selecting a threshold amount for the particular street.

5. The central monitoring server of claim 4, wherein the method further comprises:
identifying current speeds that are more than the threshold amount below the posted speed limit for the particular street.

6. The central monitoring server of claim 5, wherein the method further comprises:
designating the particular street as having slow traffic if a preset number of current speeds for the particular street are more than the threshold amount below the posted speed limit for the particular street.

7. A method for monitoring traffic flow, comprising:
receiving a message from each of a plurality of wireless devices, the messages identifying a speed and a location of the wireless device;
storing one or more wireless device speeds associated with a particular street, the particular street being identified using the location of one or more wireless devices; and
computing an observed speed limit for the particular street using the stored wireless device speeds.

8. The method of claim 7, further comprising:
comparing the observed speed limit to a posted speed limit of the particular street; and
determining a road condition based on the comparison.

9. The method of claim 8, wherein the determination of the road condition further comprises:
identifying if the observed speed limit is greater than the posted speed limit.

10. The method of claim 8, wherein the determination of the road condition further comprises:
identifying if the observed speed limit is less than the posted speed limit.

11. The method of claim 8, wherein the determination of the road condition further comprises:
identifying if the observed speed limit is less than the posted speed limit by at least a specified amount.

12. The method of claim 8, further comprising:
marking the particular street in a street mapping database if the observed speed limit for the particular street is less than the posted speed limit by more than a specified amount.

13. The method of claim 7, further comprising:
averaging two or more of the stored wireless device speeds to compute the observed speed limit.

14. The method of claim 7, further comprising:
providing the observed speed limit for the particular street in response to a query.

15. One or more computer-readable media having computer-usable instructions stored thereon for performing a method of estimating a speed limit on a street, comprising:
receiving current speed reports from wireless devices;
associating the wireless devices with a street;
computing an observed speed limit for the street using the current speed reports, wherein two or more of the current speed reports received within a specified period are averaged to compute the observed speed limit.

16. The media of claim 15, further comprising:
receiving a current location report with each current speed report from the wireless devices; and
associating the current speed reports to the street using the current location report.

17. One or more computer-readable media having computer-usable instructions stored thereon for performing a method of identifying a location of a street, comprising:
receiving current location reports from wireless devices;
searching a street mapping database using location data in the current location reports;
identifying selected location data that does not correspond to streets in the street mapping database; and
analyzing the selected location data to identify geographic areas that correspond to streets that are not found in the street mapping database.

18. The media of claim 17, further comprising:
identifying a path between two existing streets in the street mapping database, the location of the path designated by the selected location data.

19. The media of claim 18, further comprising:
adding the path to the street mapping database as a new street.
